(19) United States
(12) Patent Application Publication
(10) Pub. No.: US 2025/0063431 A1
(43) Pub. Date: Feb. 20, 2025

(54) APPARATUS, METHODS, AND COMPUTER PROGRAMS FOR PREDICTING NETWORK PERFORMANCE BEFORE TRIGGERING HANDOVER

(71) Applicant: Nokia Technologies Oy, Espoo (FI)

(72) Inventors: Amaanat ALI, Espoo (FI); Ahmad AWADA, Munich (DE); Janne ALI-TOLPPA, Pirkkala (FI); Anna PANTELIDOU, Massy (FR); Alperen GUNDOGAN, Munich (DE); Sina KHATIBI, Munich (DE)

(21) Appl. No.: 18/725,905

(22) PCT Filed: Jan. 6, 2022
(86) PCT No.: PCT/EP2022/050211

§ 371 Date: Jul. 1, 2024

(51) Int. Cl. H04W 28/08; H04W 36/36

(52) U.S. Cl. CPC H04W 28/0942; H04W 36/362

(57) ABSTRACT

An apparatus, method, and computer program for a serving network access node that causes the serving network access node to: provide a first user equipment with access to a network; signal, to a first network access node, a request for a first indication that indicates how at least one load-related parameter of the first network access node would likely be affected if the first network access node were to serve the first user equipment; receive, from the first network access node, the first indication; and make at least one load-related decision for the first user equipment in dependence on the received first indication.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

There is a need to provide control systems which enable a communications service provider (CSP) to control and optimise a complex network of communications system elements.

One of current approaches being employed is closed-loop automation and machine learning which can be built into self-organizing networks (SON) enabling an operator to automatically optimize every cell in the radio access network.

### SUMMARY

According to a first aspect, there is provided an apparatus for a serving network access node, the apparatus comprising means for: providing a first user equipment with access to a network; signalling, to a first network access node, a request for a first indication that indicates how at least one load-related parameter of the first network access node would likely be affected if the first network access node were to serve the first user equipment; receiving, from the first network access node, the first indication; and making at least one load-related decision for the first user equipment in dependence on the received first indication.

The means for making at least one load-related decision for the first user equipment in dependence on the received first indication may comprise means for: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said first indication; and when it is determined that the first network access node is a suitable network access node using said first indication, signalling the first user equipment, wherein said signalling to the first user equipment indicates that the first network access node is suitable to function as said another network access node.

The apparatus may comprise means for: signalling, to the first network access node, a request for a second indication that indicates how at least one load-related parameter of the first network access node would likely be affected if the first network access node were to serve the first user equipment, wherein the request for the second indication is signalled after the request for the first indication is signalled; receiving, from the first network access node, the second indication; and making at least one load-related decision for the first user equipment in dependence on the received second indication.

The means for making at least one load-related decision for the first user equipment in dependence on the received second indication may comprise means for: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said second indication; and, when it is determined that the first network access node is not a suitable network access node using said second indication, signalling the first user equipment, wherein said signalling to the first user equipment indicates that the first network access node is not suitable to function as said another network access node.

The apparatus may comprise means for, when it is determined that the first network access node is a suitable network access node using said first indication and when it is determined that the first network access node is not a suitable network access node using said second indication, signalling the first user equipment to indicate that the first neighbouring access node is no longer suitable to function as said another network access node.

The apparatus may comprise means for determining that at least one of a validity time of the first indication has expired, and/or that a measurement report has been received from a user equipment subsequent to the first indication being received, wherein said signalling, to the first network access node, the request for the second indication is performed response to said determining.

The apparatus may comprise means for: signalling, to a second network access node, a request for a third indication that indicates how at least one load-related parameter of the second network access node would likely be affected if the second network access node were to serve the first user equipment; receiving, from the second network access node, the third indication; and making at least one load-related decision for the first user equipment in dependence on the received third indication.

The apparatus may comprise means for: providing the received third indication to the first network access node; and providing the received first indication to the second network access node.

The apparatus may comprise means for: receiving, from at least one of the first network access node and the second network access node, a load-related decision in relation to the first user equipment.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

The apparatus may comprise means for generating said temporary identifier.

According to a second aspect, there is provided an apparatus for a first network access node, the apparatus comprising means for: receiving, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node; and signalling, to the serving network access node, the first indication.

The apparatus may comprise means for: receiving, from the serving network access node, a request for a second indication that indicates how at least one load-related parameter of the first network access node would likely be affected if the first network access node were to serve the first user equipment, wherein the request for the second indication is signalled after the request for the first indication is signalled; and signalling, to the serving network access node, the second indication.

The apparatus may comprise means for: receiving, from the serving network access node, a third indication that indicates how at least one load-related parameter of a second network access node would likely be affected if the second network access node were to serve the first user equipment; and making a load-related decision for the first user equipment using the first and/or third indication.

The apparatus may comprise means for receiving, from the first user equipment, a request to perform a handover from the serving network access node to the first network access node.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

According to a third aspect, there is provided an apparatus for a serving network access node, the apparatus comprising: at least one processor; and at least one memory comprising code that, when executed by the at least one processor, causes the apparatus to: provide a first user equipment with access to a network; signal, to a first network access node, a request for a first indication that indicates how at least one load-related parameter of the first network access node would likely be affected if the first network access node were to serve the first user equipment; receive, from the first network access node, the first indication; and make at least one load-related decision for the first user equipment in dependence on the received first indication.

The making at least one load-related decision for the first user equipment in dependence on the received first indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said first indication; and when it is determined that the first network access node is a suitable network access node using said first indication, signalling the first user equipment, wherein said signalling to the first user equipment indicates that the first network access node is suitable to function as said another network access node.

The apparatus may be caused to: signal, to the first network access node, a request for a second indication that indicates how at least one load-related parameter of the first network access node would likely be affected if the first network access node were to serve the first user equipment, wherein the request for the second indication is signalled after the request for the first indication is signalled; receive, from the first network access node, the second indication; and make at least one load-related decision for the first user equipment in dependence on the received second indication.

The making at least one load-related decision for the first user equipment in dependence on the received second indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said second indication; and, when it is determined that the first network access node is not a suitable network access node using said second indication, signalling the first user equipment, wherein said signalling to the first user equipment indicates that the first network access node is not suitable to function as said another network access node.

The apparatus may be caused to, when it is determined that the first network access node is a suitable network access node use said first indication and when it is determined that the first network access node is not a suitable network access node using said second indication, signal the first user equipment to indicate that the first neighbouring access node is no longer suitable to function as said another network access node.

The apparatus may be caused to determine that at least one of a validity time of the first indication has expired, and/or that a measurement report has been received from a user equipment subsequent to the first indication being received, wherein said signalling, to the first network access node, the request for the second indication is performed response to said determining.

The apparatus may be caused to: signal, to a second network access node, a request for a third indication that indicates how at least one load-related parameter of the second network access node would likely be affected if the second network access node were to serve the first user equipment; receive, from the second network access node, the third indication; and make at least one load-related decision for the first user equipment in dependence on the received third indication.

The apparatus may be caused to: provide the received third indication to the first network access node; and provide the received first indication to the second network access node.

The apparatus may be caused to: receive, from at least one of the first network access node and the second network access node, a load-related decision in relation to the first user equipment.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

The apparatus may be caused to generate said temporary identifier.

According to a fourth aspect, there is provided an apparatus for a first network access node, the apparatus comprising: at least one processor; and at least one memory comprising code that, when executed by the at least one processor, causes the apparatus to: receive, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node; and signal, to the serving network access node, the first indication.

The apparatus may be caused to: receive, from the serving network access node, a request for a second indication that indicates how at least one load-related parameter of the first network access node would likely be affected if the first network access node were to serve the first user equipment, wherein the request for the second indication is signalled after the request for the first indication is signalled; and signal, to the serving network access node, the second indication.

The apparatus may be caused to: receive, from the serving network access node, a third indication that indicates how at least one load-related parameter of a second network access node would likely be affected if the second network access node were to serve the first user equipment; and make a load-related decision for the first user equipment using the first and/or third indication.

The apparatus may be caused to receive, from the first user equipment, a request to perform a handover from the serving network access node to the first network access node.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

According to a fifth aspect, there is provided a method for an apparatus for a serving network access node, the method comprising: providing a first user equipment with access to a network; signalling, to a first network access node, a request for a first indication that indicates how at least one load-related parameter of the first network access node would likely be affected if the first network access node were to serve the first user equipment; receiving, from the first network access node, the first indication; and making at least one load-related decision for the first user equipment in dependence on the received first indication.

The making at least one load-related decision for the first user equipment in dependence on the received first indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said first indication; and when it is determined that the first network access node is a suitable network access node using said first indication, signalling the first user equipment, wherein said signalling to the first user equipment indicates that the first network access node is suitable to function as said another network access node.

The method may comprise: signalling, to the first network access node, a request for a second indication that indicates how at least one load-related parameter of the first network access node would likely be affected if the first network access node were to serve the first user equipment, wherein the request for the second indication is signalled after the request for the first indication is signalled; receiving, from the first network access node, the second indication; and making at least one load-related decision for the first user equipment in dependence on the received second indication.

The making at least one load-related decision for the first user equipment in dependence on the received second indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said second indication; and, when it is determined that the first network access node is not a suitable network access node using said second indication, signalling the first user equipment, wherein said signalling to the first user equipment indicates that the first network access node is not suitable to function as said another network access node.

The method may comprise, when it is determined that the first network access node is a suitable network access node using said first indication and when it is determined that the first network access node is not a suitable network access node using said second indication, signalling the first user equipment to indicate that the first neighbouring access node is no longer suitable to function as said another network access node.

The method may comprise determining that at least one of a validity time of the first indication has expired, and/or that a measurement report has been received from a user equipment subsequent to the first indication being received, wherein said signalling, to the first network access node, the request for the second indication is performed response to said determining.

The method may comprise: signalling, to a second network access node, a request for a third indication that indicates how at least one load-related parameter of the second network access node would likely be affected if the second network access node were to serve the first user equipment; receiving, from the second network access node, the third indication; and making at least one load-related decision for the first user equipment in dependence on the received third indication.

The method may comprise: providing the received third indication to the first network access node; and providing the received first indication to the second network access node.

The method may comprise: receiving, from at least one of the first network access node and the second network access node, a load-related decision in relation to the first user equipment.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

The method may comprise generating said temporary identifier.

According to a sixth aspect, there is provided a method for an apparatus for a first network access node, the method comprising: receiving, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node; and signalling, to the serving network access node, the first indication.

The method may comprise: receiving, from the serving network access node, a request for a second indication that indicates how at least one load-related parameter of the first network access node would likely be affected if the first network access node were to serve the first user equipment, wherein the request for the second indication is signalled after the request for the first indication is signalled; and signalling, to the serving network access node, the second indication.

The method may comprise: receiving, from the serving network access node, a third indication that indicates how at least one load-related parameter of a second network access node would likely be affected if the second network access node were to serve the first user equipment; and making a load-related decision for the first user equipment using the first and/or third indication.

The method may comprise for receiving, from the first user equipment, a request to perform a handover from the serving network access node to the first network access node.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

According to a seventh aspect, there is provided an apparatus for a serving network access node, the apparatus comprising: providing circuitry for providing a first user equipment with access to a network; signalling circuitry for signalling, to a first network access node, a request for a first indication that indicates how at least one load-related parameter of the first network access node would likely be affected if the first network access node were to serve the first user equipment; receiving circuitry for receiving, from the first network access node, the first indication; and making circuitry for making at least one load-related decision for the first user equipment in dependence on the received first indication.

The making circuitry for making at least one load-related decision for the first user equipment in dependence on the received first indication may comprise: determining circuitry for determining that the first user equipment is configured to initiate a handover from the serving network access node to another network access node when the first user equipment determines that at least one execution condition is fulfilled at the first user equipment; determining circuitry for determining whether the first network access node is a suitable network access node to function as said another network access node using said first indication; and signalling circuitry for, when it is determined that the first network access node is a suitable network access node using said first indication, signalling the first user equipment, wherein said signalling to the first user equipment indicates that the first network access node is suitable to function as said another network access node.

The apparatus may comprise: signalling circuitry for signalling, to the first network access node, a request for a second indication that indicates how at least one load-related parameter of the first network access node would likely be affected if the first network access node were to serve the first user equipment, wherein the request for the second indication is signalled after the request for the first indication is signalled; receiving circuitry for receiving, from the first network access node, the second indication; and making circuitry for making at least one load-related decision for the first user equipment in dependence on the received second indication.

The making circuitry for making at least one load-related decision for the first user equipment in dependence on the received second indication may comprise: determining circuitry for determining that the first user equipment is configured to initiate a handover from the serving network access node to another network access node when the first user equipment determines that at least one execution condition is fulfilled at the first user equipment; determining circuitry for determining whether the first network access node is a suitable network access node to function as said another network access node using said second indication; and, signalling circuitry for when it is determined that the first network access node is not a suitable network access node using said second indication, signalling the first user equipment, wherein said signalling to the first user equipment indicates that the first network access node is not suitable to function as said another network access node.

The apparatus may comprise, using circuitry for, when it is determined that the first network access node is a suitable network access node using said first indication and signalling circuitry for, when it is determined that the first network access node is not a suitable network access node using said second indication, signalling the first user equipment to indicate that the first neighbouring access node is no longer suitable to function as said another network access node.

The apparatus may comprise determining circuitry for determining that at least one of a validity time of the first indication has expired, and/or that a measurement report has been received from a user equipment subsequent to the first indication being received, wherein said signalling, to the first network access node, the request for the second indication is performed response to said determining.

The apparatus may comprise: signalling circuitry for signalling, to a second network access node, a request for a third indication that indicates how at least one load-related parameter of the second network access node would likely be affected if the second network access node were to serve the first user equipment; receiving circuitry for receiving, from the second network access node, the third indication; and making circuitry for making at least one load-related decision for the first user equipment in dependence on the received third indication.

The apparatus may comprise: providing circuitry for providing the received third indication to the first network access node; and providing circuitry for providing the received first indication to the second network access node.

The apparatus may comprise: receiving circuitry for receiving, from at least one of the first network access node and the second network access node, a load-related decision in relation to the first user equipment.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

The apparatus may comprise generating circuitry for generating said temporary identifier.

According to an eighth aspect, there is provided an apparatus for a first network access node, the apparatus comprising: receiving circuitry for receiving, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node; and signalling circuitry for signalling, to the serving network access node, the first indication.

The apparatus may comprise: receiving circuitry for receiving, from the serving network access node, a request for a second indication that indicates how at least one load-related parameter of the first network access node would likely be affected if the first network access node were to serve the first user equipment, wherein the request for the second indication is signalled after the request for the first indication is signalled; and signalling circuitry for signalling, to the serving network access node, the second indication.

The apparatus may comprise: receiving circuitry for receiving, from the serving network access node, a third indication that indicates how at least one load-related parameter of a second network access node would likely be affected if the second network access node were to serve the first user equipment; and making circuitry for making a load-related decision for the first user equipment using the first and/or third indication.

The apparatus may comprise receiving circuitry for receiving, from the first user equipment, a request to perform a handover from the serving network access node to the first network access node.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

According to a ninth aspect, there is provided non-transitory computer readable medium comprising program instructions for causing an apparatus for a serving network access node to perform at least the following: provide a first user equipment with access to a network; signal, to a first network access node, a request for a first indication that indicates how at least one load-related parameter of the first network access node would likely be affected if the first network access node were to serve the first user equipment; receive, from the first network access node, the first indication; and make at least one load-related decision for the first user equipment in dependence on the received first indication.

The making at least one load-related decision for the first user equipment in dependence on the received first indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said first indication; and when it is determined that the first network access node is a suitable network access node using said first indication, signalling the first user equipment, wherein said signalling to the first user equipment indicates that the first network access node is suitable to function as said another network access node.

The apparatus may be caused to: signal, to the first network access node, a request for a second indication that indicates how at least one load-related parameter of the first network access node would likely be affected if the first network access node were to serve the first user equipment, wherein the request for the second indication is signalled after the request for the first indication is signalled; receive, from the first network access node, the second indication; and make at least one load-related decision for the first user equipment in dependence on the received second indication.

The making at least one load-related decision for the first user equipment in dependence on the received second indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said second indication; and, when it is determined that the first network access node is not a suitable network access node using said second indication, signalling the first user equipment, wherein said signalling to the first user equipment indicates that the first network access node is not suitable to function as said another network access node.

The apparatus may be caused to, when it is determined that the first network access node is a suitable network access node use said first indication and when it is determined that the first network access node is not a suitable network access node using said second indication, signal the first user equipment to indicate that the first neighbouring access node is no longer suitable to function as said another network access node.

The apparatus may be caused to determine that at least one of a validity time of the first indication has expired, and/or that a measurement report has been received from a user equipment subsequent to the first indication being received, wherein said signalling, to the first network access node, the request for the second indication is performed response to said determining.

The apparatus may be caused to: signal, to a second network access node, a request for a third indication that indicates how at least one load-related parameter of the second network access node would likely be affected if the second network access node were to serve the first user equipment; receive, from the second network access node, the third indication; and make at least one load-related decision for the first user equipment in dependence on the received third indication.

The apparatus may be caused to: provide the received third indication to the first network access node; and provide the received first indication to the second network access node.

The apparatus may be caused to: receive, from at least one of the first network access node and the second network access node, a load-related decision in relation to the first user equipment.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

The apparatus may be caused to generate said temporary identifier.

According to a tenth aspect, there is provided non-transitory computer readable medium comprising program instructions for causing an apparatus for a first network access node to perform at least the following: receive, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node; and signal, to the serving network access node, the first indication.

The apparatus may be caused to: receive, from the serving network access node, a request for a second indication that indicates how at least one load-related parameter of the first network access node would likely be affected if the first network access node were to serve the first user equipment, wherein the request for the second indication is signalled after the request for the first indication is signalled; and signal, to the serving network access node, the second indication.

The apparatus may be caused to: receive, from the serving network access node, a third indication that indicates how at least one load-related parameter of a second network access node would likely be affected if the second network access node were to serve the first user equipment; and make a load-related decision for the first user equipment using the first and/or third indication.

The apparatus may be caused to receive, from the first user equipment, a request to perform a handover from the serving network access node to the first network access node.

The first indication may comprise at least one of: a physical resource block utilisation at at least one of: a protocol data unit session level, a Data Resource Bearer level, carrier level, and/or a frequency band level; a probability that a quality of service requirement of a session of the first user equipment will be violated subsequent to a handover of the first user equipment to the first neighbouring network access network node; a validity time indicating a time duration for how long the first indication is valid; a probability that a session of the first user equipment will be dropped subsequent to a handover of the first user equipment to the first neighbouring network access network node; and an indication of a predicted degradation in a quality of service requirement of a session of the first user equipment subsequent to a handover of the first user equipment to the first neighbouring network access network node.

The request for the first indication may relate to a single user equipment, and/or wherein the request for the third indication may relate to a plurality of user equipment.

The request for the first indication may comprise at least one of: a channel quality indicator estimated based on a trajectory of the first user equipment; an arrival rate of packets at the first user equipment per session of the first user equipment; and service and/or slice information related to a service and/or slice provided at the first user equipment.

The request for the first indication may comprise a temporary identifier of the first user equipment.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Examples will now be described, by way of example only, with reference to the accompanying Figures in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6 to 9 illustrate example signalling procedures; and

FIGS. 10 and 11 are flow charts illustrating example operations that may be performed by apparatus described herein.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals).

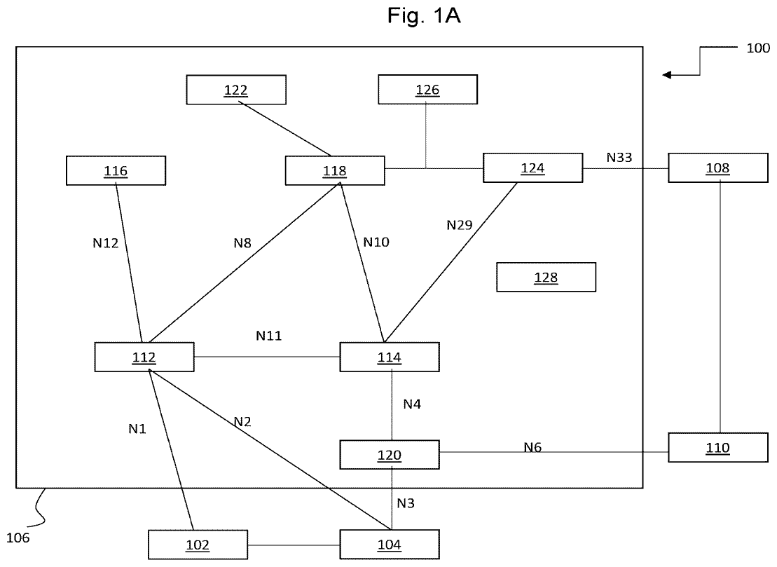

Before explaining in detail the exemplifying embodiments, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, etc.) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS). The MDAS may provide data analytics of different network related parameters including for example load level and/or resource utilisation. For example, the MDAS for a network function (NF) can collect the NF's load related performance data, e.g., resource usage status of the NF. The analysis of the collected data may provide forecast of resource usage information in a predefined future time. This analysis may also recommend appropriate actions e.g., scaling of resources, admission control, load balancing of traffic, etc.

FIG. 1B shows a schematic representation of a 5GC 106′ represented in current 3GPP specifications.

FIG. 1B shows a UPF 120′ connected to an SMF 114′ over an N4 interface. The SMF 114′ is connected to each of a UDR 122′, an NEF 124′, an NWDAF 126′, an AF 108′, a Policy Control Function (PCF) 130′, an AMF 112′, and a Charging function 132′ over an interconnect medium that also connects these network functions to each other.

3GPP refers to a group of organizations that develop and release different standardized communication protocols. 3GPP is currently developing and publishing documents related to Releases 16 to 18, relating to 5G technology.

A new Study Item RP-201620 “Study on enhancement for data collection for NR and Evolved-Universal Terrestrial Radio Access New Radio Dual Connectivity (EN-DC) was started in November 2020. The general objectives of this Study Item was to study high level principles for enabling artificial intelligence (AI) in a Radio Access Network (RAN) and to study the functional framework for such an enabling, including the AI functionality and the inputs and outputs needed by a machine learning (ML) algorithm. Specifically, the Study Item aimed to identify the data needed by an AI function in the input and the data that is output by the AI function, as well as any impact this has on a node in the existing architecture or in the network interfaces to transfer this input/output data through them, particularly from a standardization point of view.

Prediction-based operations have been widely discussed for use in methods for improving performance of various operations that are performed in a network. For example, prediction of a UE trajectory or future location can be useful for determining how to adjust handover-related thresholds (for example, cell individual offset or to select the Radio Area Network based Notification Area (RNA) in Radio Resource Control (RRC) INACTIVE mode). Prediction of a UE location may further help when determining how to allocate network resources for various use cases, including energy saving, load balancing and mobility management. As another example, handover decisions may be improved by using prediction-based information on a UE performance at the target cell. Energy saving decisions taken locally at a cell may be improved by utilizing prediction information on incoming UE traffic, as well as prediction information about traffic that may be offloaded from a candidate energy-saving cell to a neighbour cell when ensuring coverage.

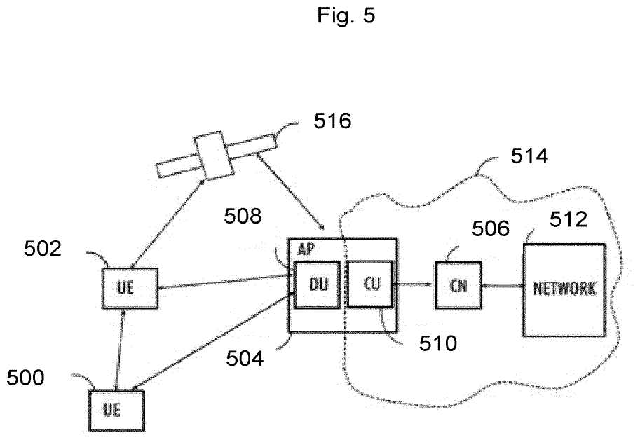

Load balancing performance can be improved by introducing an algorithm (or an AI/ML model) for decisions that rely, at least in part, on the collection of various measurements and feedbacks from UEs and/or network nodes. Predicted load information may also improve load balancing performance by providing higher Quality of Service (QOS) and enhanced system performance. A high-level signalling flow for the AI/ML use case related to Load Balancing is shown in FIG. 6.

FIG. 6 illustrates signalling that may be performed between a UE 601, a first Radio Access Network (RAN) node 602, and a second RAN node 603. The first RAN node and the second RAN node 603 may be neighbouring RAN nodes. The first RAN node and the second RAN node may both facilitate access to the same network. The UE 601 may initially be configured to connect to the network through the first RAN node. Throughout this, and subsequent example descriptions, it is understood that a RAN node may be, for example, a Next Generation (NG)-RAN eNB and/or gNB.

At 6001, the first RAN node is configured to execute a first AI/ML Model Training. The second RAN node 603 may be assumed to have capabilities in providing the first RAN node 602 with useful input information for this purpose. For example, the second RAN node 603 may provide the first RAN node 602 with a predicted resource status for the second RAN node and/or mobility predictions for at least the UE 601.

At 6002, the first RAN node 602 signals the UE 601. This signaling of 6002 may be a request for the UE to provide measurement-related and/or location-related information. For example, the UE 601 may be requested to provide Radio Resource Management (RRM) measurements, minimization of drive test (MDT)-related measurements, a velocity of the UE 601, a geographical position of the UE 601, etc.

At 6003, the UE 601 signals the first RAN node 602. This signaling of 6003 may be a response to the request of 6002. The signalling of 6003 may provide at least some of the requested information of 6002. The signaling of 6003 may provide all of the requested information of 6002.

At 6004, the first RAN node 602 signals the second RAN node 603. This signalling of 6004 may request resource status information from the second RAN node.

At 6005, the second RAN node 602 signals the first RAN node 602. This signalling of 6003 may be a response to the signalling of 6004. This signalling of 6003 may provide at least some of the requested information of 6004. The signalling of 6003 may provide all of the requested information of 6004.

At 6006, the first RAN node 602 performs mobility load balancing predictions. These mobility load balancing predictions may be predictions in relation to cells of the first RAN node 602.

At 6007, the first RAN node makes mobility load balancing decisions based on the predictions of 6006, and cause the UE 601 and/or the second RAN node 603 to effect at least part of one of these decisions. For example, a decision of 6007 may cause the UE 601 to move from the first RAN node 6002 to the second RAN node 6003 (i.e. to connect to a network via the second RAN node 6003 instead of via the first RAN node 6002).

At 6008, the second RAN node 603 signals the first RAN node 602. This signalling of 6008 may provide feedback to the first RAN node 602 regarding how the effected decisions of 6007 have affected the second RAN node 603. For example, this feedback may provide an indication of resource status updates after load balancing.

Another use case for AI/ML in RAN is mobility optimization. In particular, the average coverage area of a single RAN node is expected to decrease in future wireless networks compared to current or historic RAN nodes. This is expected to be a result of increasing of carrier frequency (e.g. to comprise Frequency Range (FR) 2), which leads to higher number of handover between nodes, especially for the users with high velocity. Hence, mobility management becomes a more important for future networks that are configured to sustain stringent QoS requirements (e.g., reliability, latency, etc.) for many applications.

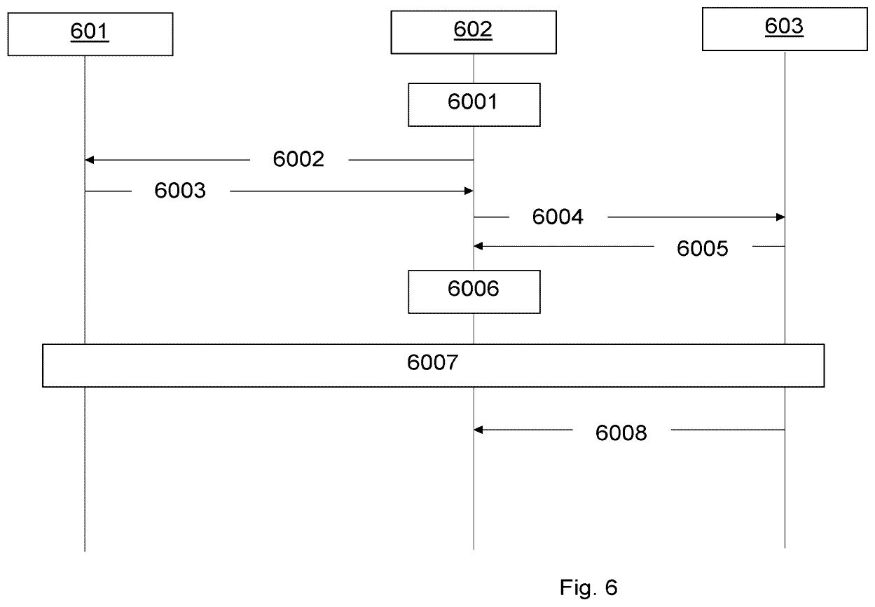

FIG. 7 illustrates such a mobility optimization operation for the case where model training and inference located in at least one RAN node.

FIG. 6 illustrates signalling that may be performed between a UE 701, a first Radio Access Network (RAN) node 702, and a second RAN node 703. The first RAN node and the second RAN node 703 may be neighbouring RAN nodes. The first RAN node and the second RAN node may both facilitate access to the same network. The UE 701 may initially be configured to connect to the network through the first RAN node.

At 7001, the first RAN 702 signals the UE 701. This signalling of 7001 may configure the UE 701. Such a configuration of 7001 may cause the UE 701 to make and/or to collect information relating to measurements the measurement information on the UE side. This configuration may further cause the UE 701 to report the measurements and/or to report at least an indication of a result of the measurements.

At 7002, the UE 701 performs and/or collects measurements in accordance with the configuration of 7001. The UE measurements may comprise values relating to at least one of: a Reference Signal Received Power (RSRP), Reference Signal Received Quality (RSRQ), and/or a signal to interference and noise ratio (SINR) of a serving cell provided to the UE 701 by the first RAN node 702 and/or neighbouring cells. How to determine an RSRP, RSRQ, and SINR is defined by 3GPP standards.

At 7003, the UE 702 signals the first RAN node 702. This signalling of 7003 may comprise, or otherwise indicate, a measurement report that indicates a result of at least one of the measurements of 7002.

At 7004, the first RAN node 702 performs model training using at least one of the measurement result(s) of 7003. In particular, the provided measurements may be leveraged to train at least one machine learning model for mobility optimization.

At 7005, the UE 701 signals the first RAN node 702. This signalling of 7005 may comprise another measurement report that is similar to the measurement report of 7003, except being updated to comprise at least one indication of a measurement result obtained from a measurement performed between 7003 and 7005.

At 7006, the first RAN node 702 may perform model inference. In this step, the measurement results provided during 7005 and 7003 are used to improve a model inference in at least one AI/ML model (relative to AI/ML models that do not use such measurement results) to output at least one prediction. The at least one prediction may comprise at least one of: a trajectory prediction for the UE 701, a target cell prediction, a target RAN node prediction, etc.

At 7007, at least one action is performed in response to at least one of the prediction with the aim of minimizing negative effects on the network and/or optimizing network performance in response to a predicted mobility of the UE 701.

At 7008, the first RAN node 702 effects at least one of the actions of 7007 by sending a handover request message to the second RAN node 703. This handover request message may request that the second RAN node 703 provide access to the network for the UE 701 instead of the first RAN node 702.

During a recent3 GPP meeting, it was agreed to include predicted resource status and predicted performance information to improve mobility decisions. In particular, it was agreed to improve mobility decisions at a gNB (e.g. a gNB Centralised Unit (CU)) by allowing the gNB to request mobility feedback from a neigbouring node. How this was to be achieved was for future study, although it was noted that it at potentially impact the direct interface between the gNB and the neighbouring node (i.e. this request may have an impact on the Xn interface).

Resource status reporting initiation procedure is defined in 3GPP TS 38.423. Currently, this process is used by a Next Generation (NG)-Radio Access Network (RAN) node, such as a gNB, to request the reporting of load measurements to another NG-RAN node. In the language of the above examples, the first RAN node may initiate the resource status reporting procedure by sending the RESOURCE STATUS REQUEST message to the second RAN to start a measurement, stop a measurement, and/or to add cells to be reported on by the second RAN in a measurement report.

When starting a measurement, a Report Characteristics Information Element (IE) in the RESOURCE STATUS REQUEST indicates the type of objects the second RAN node is requested to perform measurements on. The response from the second RAN node to the first RAN node (also called a “RESOURCE STATUS RESPONSE”) may comprise a Radio Resource Status IE if requested by the first RAN node in prior signalling. This Radio Resource Status IE indicates the usage of the Physical Resource Blocks (PRBs) per cell and per Synchronization Signal Block (SSB) area for traffic in a downlink and/or an uplink direction, as well as the usage of Physical Downlink Control Channel (PDCCH) Control Channel Elements (CCEs) for use when downlink and uplink scheduling. Scheduling may be performed by a Medium Access Control (MAC) entity either located inside a gNB-Distributed Unit (DU) in a distributed architecture (i.e., an architecture comprising at least one gNB-Centralised Unit (CU) and at least one gNB-DU) or located inside a gNB when both a gNB-CU and a gNB-DU are co-located in a centralized implementation of gNB.

During a handover preparation procedure in a Release 17 network implementation, a serving access node (i.e. the node a UE is currently using to connect to a network) forwards UE access stratum context for a UE to a target node (i.e. the node that a UE is being handed over to by the serving access node). The UE access stratum information may comprise a source RRC configuration of the UE. The source RRC configuration may comprise information defining at least part of: a Protocol Data Unit (PDU) sessions; Data Resource Bearers allocated to the UE to be handed over; and/or the radio access capabilities of the UE being handed over.

The target node may use at least part of the UE access stratum information when performing admission control for this UE. The target node may use other information when performing admission control for this UE. The target node may use information relating to at least one PDU session associated with the UE, Quality of Service (QOS) requirement(s) for at least one service being provided to the UE, a current load in target cell relative to the target cell's capacity, UE measurements, etc. The target node may, at part of performing admission control, signal a radio reconfiguration message (e.g., a handover command) that is returned to the serving access node to be provided to the UE. The whole process is currently based on an instantaneous admission control situation assessed by the target node.

In current network implementations, the load balancing and mobility decisions in the network are mainly passive. This means that these decisions presently rely on a current and/or past state of a cell load status and correcting for failures after being detected. These corrections may be made, for example, in self-organizing networks. For example, where a Key Performance Indicator like handover successes and failures are counted, an algorithm may improve a control parameter that reduces the number of failures and improves the handover successes.

However, these passive approaches may be insufficient as they do not take into account dynamic conditions. In contrast, active approaches, where failures are avoided by means of estimation or prediction, have proven to be better solutions. The use of more agile/active approaches is more important when there are a rapid changes of traffic load and/or resource status. This may be a result of, for example, network slicing, as well as broad service verticals, such as, for example, enhanced Mobile Broadband (eMBB), ultra-reliable low latency communication (URLLC) and massive Machine Type Communications (mMTC) traffic, in practical 5G networks. It may therefore be no longer practical to plainly rely on a purely static approach of cell load status as an estimation of resource status, especially in scenarios involving high-mobility and large number of connections (including dual connectivity, which may lead to ping-pong handover between different cells), cell overload, and degradation of user service quality under both Frequency Range 1 (FR1) and Frequency Range 2 (FR2) deployments.

Some previous work has discussed related aspects to the above.

In one example, a serving access node is configured to predict in advance how a UE might be treated at a target node based on a transferred target network nodes' footprint, where a footprint may be considered to be a functionality (e.g. transfer/system function) of a target network node that is abstracted in a format that may be utilized by a serving/source access node to predict what that target network node will configure for a given UE even before the target network node is consulted by an explicit message. The serving access node may determine to not initiate a handover preparation to a given target node following a local consultation/inference made using the UE's configuration applied to the target network nodes' footprint.

In another example, a message sent by a first RAN node to a second RAN node may initiate that measurements be made according to at least one parameter provided in the message. This provides information transacted at a per-node level, but does not allow for granularity of a per-UE estimate of load/resource load/resource utilization, let alone at an even more granular reporting at PDU session level, and/or at a quasi-co-location (QCL)-level, and/or at a slice specific level. Also, there are no methods for improving these predictions by taking predicted mobility and traffic of the inbound mobile UEs into account.

In light of the above discussion, the following considers ways of addressing at least one of the following issues:
1) Issues arising from when a target node does not consider predicted traffic measurement information from potential serving access nodes when making mobility-related decisions.
2) Issues arising from when the serving access node is only aware of the load of a potential target node but does not know the actual incident load the UE will create on the target node: Having more information on the potential additional load that would be created as a result of a handing over a UE from the serving access node to a target node would allow the serving access node to perform a better mobility decision as different target nodes may provide a different target configurations. For example, one target node may configure a cell offering joint transmission scheme or it may enable receive beamforming enabling better MCS and hence better spectral efficiency.

From the perspective of a network node implementation, it is assumed that a serving access node NG-RAN eNB/gNB (including both centralized units (CUs) and distributed units (DUs) in the distributed architecture), is able to calculate a Physical Resource Block (PRB) utilization for a target node when the serving access node knows a UE-specific information (capabilities and band combination). This calculation may be labelled as a function, CALC_LOAD (PARAMS), where PARAMS refers to the input parameters to the load calculation algorithm.

The UE-specific information may comprise UE access stratum and/or radio capability. The UE access stratum and/or radio capability may comprise at least one of: physical layer-related band/band combinations, carrier aggregation-related capabilities, supported modulations (e.g., 1024 or 256 quadrature amplitude modulation), channel bandwidths for Frequency Range 1 (FR1) and Frequency Range 2 (FR2), sub-carrier spacing, medium access control layer related capabilities (e.g. configured grant, uplink skipping, Discontinuous Reception (DRX), power headroom reporting, logical channel prioritization and/or capabilities of each feature the UE supports for the described feature capabilities in TS 38.306. The UE access stratum and/or radio capability signalling may be as described in TS 38.331, which currently describes how the UE signals its capabilities in different structures where each capability parameter is defined per UE, per duplex mode (e.g. Frequency Division Duplex (FDD)/Time Division Duplex (TDD)), per frequency range (FR1/FR2), per band, and/or per band combinations. Some capability parameters are always defined per UE (e.g. Packet Data Convergence Protocol (PDCP, which is a layer that lies between Radio Resource Control (RRC) on the upper side and Radio Link Control (RLC) on the lower side of the control protocol stack), Service Data Adaptation Protocol (SDAP, which is a sub-layer of 5G NR radio protocol stack located above PDCP), and RLC parameters), while other parameters are not always defined at a per-UE (e.g. MAC and Physical Layer Parameters). The UE access stratum and/or radio capability may comprise tens of thousands of octets of information. For example, the UE access stratum and/or radio capability information often comprises 20k-30k of octets of information, going upwards to even 75k-80k octets for a powerful UE supporting most/all of the features in the specifications.

One possible enhancement for calculating this PRB utilization would be to provide a prediction of an average radio-specific Key Performance Index (KPI) (for example, CQI, a spectral efficiency, etc.) at at least one of a QCI level, slice level, and service level that the UE being handed over is expected to be served under a given set of cells and beams in a given target node.

Given this background, a network node may be able to predict the resource load of UE(s) if the traffic demand is known (e.g. depending the UEs apps and history to predict how much throughput from each QoS class is going to be requested).

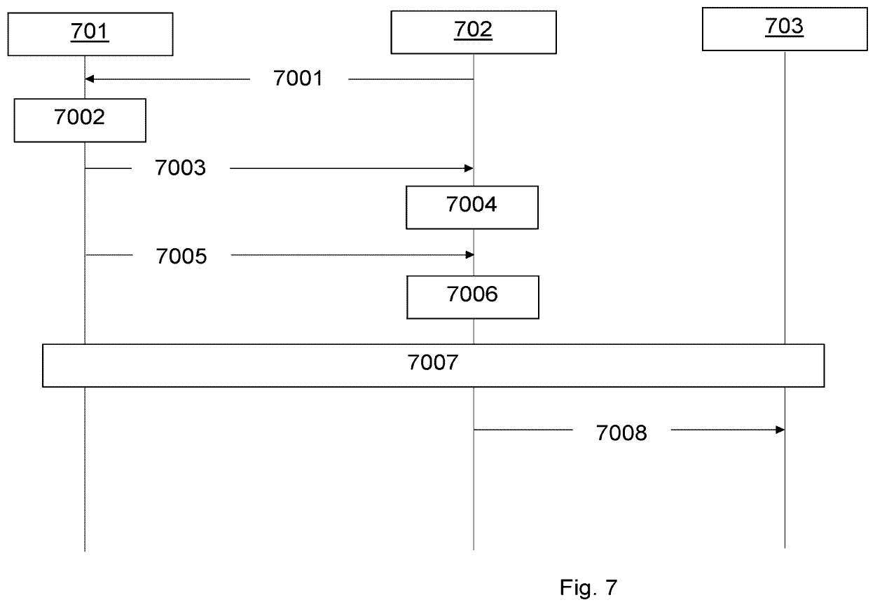

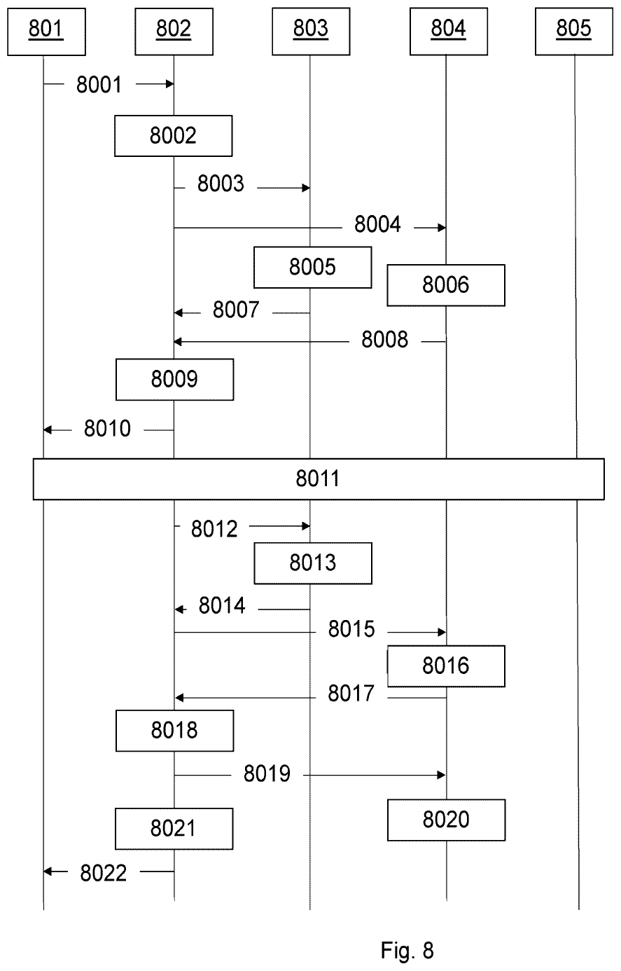

This is illustrated with respect to the examples of FIGS. 8 and 9.

In the example of FIG. 8, a serving access node provides a candidate target node for handover with predicted information that can assist the target node in estimating/predicting its likely load when the UE actually hands over to this target node.

As a response, the receiving target node may provide the sending serving access node with performance-related information on the admitted PDU sessions of the UE.

One way of how to perform this example is for the serving access node to signal a request for “Resource Utilization Request Info” during a conditional handover (CHO) preparation procedure to one or more potential target gNB(s). The target gNB(s) may subsequently provide feedback to the source gNB indicating an anticipated incident load due to incoming mobility of only this UE over a time window of duration “X”. This feedback may comprise at least one of the following pieces of additional information:
A probability indicating whether the QoS requirements of a given admitted PDU session associated with the UE being handed over are likely to be violated after the handover.
A probability that a given PDU session associated with the UE being handed over is likely to be dropped after the handover.
A predicted level of degradation that the UE may experience in QoS for a given PDU session after the handover.
Predicted load and resource requirement of a PDU session

In this example of FIG. 8, a serving access node may utilize the received resource utilization response from a target node (Resource Utilization Response) to estimate an associated “quality” of the handover from the impact on the target's load. The serving access node may use the estimated associated qualities for the range of target nodes to prioritize handover decisions over the given target cells, and/or to trigger load balancing actions. A load balancing action is an action that causes a UE to offload signalling from a given set of frequencies that are more heavily loaded towards another set of frequencies that are less heavily loaded. A procedure for performing load balancing comprises configuring a UE to measure the target frequencies before using the measurements made by the UE to decide which set of frequencies the UE must be handed over to offload traffic away from the loaded frequencies. Once the decision is made, the UE is then caused to use the decided set of frequencies instead of the current set of frequencies used by the UE.

FIG. 8 illustrates signalling that may be performed between a UE 801, a serving access node 802, a first target node 803, a second target node 804, and a location management function 805.

During 8001, the UE 801 signals the serving access node 802. This signalling of 8001 may comprise a measurement report. The measurement report comprises values corresponding to at least one measurement made by the UE 801. The measurements made by the UE 801 may be performed at a ‘beam level’ and/or a ‘cell level’. The level at which the measurements are made may be reported within a Radio Resource Control (RRC) message corresponding to a signal quality e.g., RSRP, RSRQ, and/or SINR. The cell(s) and beam(s) measured by the UR 801 may correspond to a set of frequencies configured by the network in a measurement configuration in a downlink RRC message. This configuration message may comprise, or otherwise be tagged by a measurement identifier, which may also be comprised in the measurement report to allow the network to match a measurement report to a corresponding measurement and reporting configuration.

During 8002, the serving access node 802 determines, based on values comprised in the received measurement report and at least one of a geographical location of the UE 801 and/or a trajectory of the UE 801, that a conditional handover may be appropriate. A conditional handover (CHO) is defined as a handover that is executed by the UE when one or more handover execution conditions are met. Therefore, the serving access node 802 aims to provide a UE with details of at least one candidate/target access node through which the UE 801 may connect to the network when those one or more handover execution conditions are met. To effect this, the serving access node obtains information on the target nodes available to the UE 801 in the subsequent steps.

Although not shown, the geographical location and/or the trajectory of the UE 801 may be obtained by signalling a request for this information to the LMF 805. However, it is understood that this information may be obtained in some other way. For example, this information may be obtained by performing a ranging operation between the serving access node 802 and the UE 801. As another example, this information may be provided to the serving access node 802 by the UE 801.

During 8003, the serving access node signals the first target node 803. This signalling may comprise a conditional handover request. This conditional handover request may comprise a resource utilization request information for preparing the first target node 803 for a conditional handover. The resource utilization request information/signalling of 8005 may comprise at least one of:
a prediction of Channel Quality Indicators (CQIs) or an average CQI that has been determined based on UE trajectory: The location/positional information may comprise an indication or record of some radio resource efficiency Key Performance Indicators (such as, for example, channel quality indicators (CQIs), an average throughput per Physical Resource Block, etc.) for UEs with a similar path, which may be used to predict a CQI at a serving access node and/or a target node for future UEs moving along the same or similar trajectory.
A traffic demand of the UE: A traffic demand may indicate an arrival rate of packets for the UE 801 per PDU session associated with the UE 801. This information may be determined, or may be known, depending on the UE's applications and history. This traffic demand may be used to predict how much throughput from each QoS class is going to be requested by the UE for its associated PDU sessions. The traffic demand of the UE may be provided by the UE based on an assessment made by the UE of the applications and services running in the UE and a prediction may be made by the UE on what UE predicts to be the data volume it will likely need over a given window of time (e.g., a duration of “X”). The value of this given window of time may be defined by a communication standard. The value of this given window of time may be defined by a network operator. The value of this given window of time may be determined by the serving access node. The value of this given window of time may be defined by the UE. The value of this given window of time may be of the order of every few hundreds of msecs.
QCI/service/slice differentiation information: This information may be usable to allow the computation of a metric at the target node that can be interpreted unambiguously due to common understanding across network nodes (e.g. the load KPI's may not be unambiguous as typically all vendors have their own ways of measuring load)

During 8004, the serving access node 802 signals the second target node 804. This signalling may comprise a conditional handover request. This conditional handover request may comprise resource utilization request information for preparing the second target node 804 for a conditional handover. This resource utilization request information may comprise similar, or the same, information as the signalling of 8003.

During 8005, the first target node 803 calculates a first predicted incident load at the first target node using the information provided during 8003. An incident load relates to a resource load associated with a particular event and/or set of events occurring (i.e., in the present case, given the current reported measurements and a set of current network conditions). A resource load may be measured from a physical resource block utilization within a given cell/beam of the target node. Furthermore, a resource load may also be related to transmission power limitation on a cell and/or beam (depending on whether the measurements are made at a cell-level or at a beam-level respectively) as the power amplifier is usually shared across cells.

An incident load (per UE or for a group for UE(s)) may be defined by the network in any appropriate manner. Providing more specific examples of the above, the incident load may be considered to be at least one of the following:
A utilization of downlink and uplink physical resource blocks at the physical layer
A load on the computing (CPU) and software processing resources (e.g. memory) at an access node
A load on at least one particular/identified software processes at a network node e.g. due to MIMO/beamforming processing.
A load on the transport interfaces, e.g. backhaul (between access nodes and between an access node and the core network) and fronthaul links (e.g. between a gNB centralized unit and gNB distributed units)
A transmission power on a cell/beam.

During 8006, the second target node 804 calculates a second predicted incident load at the second target node using the information provided during 8004.

During 8007, the first target node 803 signals the serving access node 802. This signaling of 8007 may be a conditional handover acknowledgment message. This signalling of 8007 may be a response to the signalling during 8003. This signalling of 8007 may comprise a resource utilization response. The resource utilization response may comprise an indication of the first incident load. In other words, the signalling of 8007 may comprise an indication of the first incident load.

The Resource Utilization Response may comprise at least the following information for this particular UE for a given window of time for which the traffic demand was sent.
At a per PDU session level (and/or at a per Data Resource Bearer level)
   A Physical Resource Block (PRB) utilization for this particular UE
   A measure of acceptance for this particular UE. This may be measured based on any predetermined scale. For example, assuming a load tolerable percentage of 0-100, a value of 0 may indicate that the UE is fully tolerable, a value of 50 may indicate that the UE is partially tolerable, and a value of 100 may indicate that the UE is fully intolerable. Any suitable scale may be used.
At a per-frequency band level (and/or per-component carrier level in case of carrier aggregation in a particular frequency band)
   A target cell/beam PRB load for a target cell and/or beam provided by the first target node for this particular UE
   A percentage of a total target cell/beam PRB load for a target cell and/or beam provided by the first target node for this particular UE
A probability indicating whether at least one Quality of Service (QOS) requirement of a given admitted PDU session of the UE 801 will likely be violated after the handover to the first target node
A probability indicating whether a given protocol data unit (PDU) session of the UE 801 will likely be dropped after the handover
A degradation in Quality of Service (QOS) for a given PDU session that the UE 801 is predicted to likely experience if the UE 801 is handed over to the first target node
A “validity time” that indicates for how long the predicted information is valid for the above information. Handovers which are likely to occur after this validity time may be the subject of a new consultation from the serving access node

During 8008, the second target node 804 signals the serving access node 802. This signaling of 8008 may be a conditional handover acknowledgment message. This signalling of 8008 may be a response to the signalling during 8004. This signalling of 8008 may comprise a resource utilization response. The resource utilization response may comprise an indication of the second incident load. In other words, the signaling of 8008 may comprise an indication of the second incident load.

The Resource Utilization Response may comprise at least the following information for this particular UE for a given window of time for which the traffic demand was sent.
At a per PDU session level (and/or at a per Data Resource Bearer level)
   A Physical Resource Block (PRB) utilization
   A measure of acceptance for this particular UE. This may be measured based on any predetermined scale. For example, assuming a load tolerable percentage of 0-100, a value of 0 may indicate that the UE is fully tolerable, a value of 50 may indicate that the UE is partially tolerable, and a value of 100 may indicate that the UE is fully intolerable. Any suitable scale may be used.
At a per-frequency band level (and/or per-component carrier level in case of carrier aggregation in a particular frequency band)
   A target cell/beam PRB load for a target cell and/or beam provided by the second target node
   A percentage of a total target cell/beam PRB load for a target cell and/or beam provided by the second target node
A probability indicating whether at least one QoS requirement of a given admitted PDU session of the UE 801 will likely be violated after the handover to the second target node
A probability indicating whether a given PDU session of the UE 801 will likely be dropped after the handover
A degradation in Quality of Service (QOS) for a given PDU session that the UE 801 is predicted to likely experience if the UE 801 is handed over to the second target node
A “validity time” that indicates for how long the predicted information is valid for the above information. Handovers which are likely to occur after this validity time may be the subject of a new consultation from the serving access node

During 8009, the serving access node 802 determines whether, for each of the first and second target nodes, conditional handover is feasible. The serving access node may use the received signalling of 8007 to make this determination for the first target node. The serving access node may use the signalling of 8008 to make this determination for the second target node.

For example, determining whether or not a conditional handover is feasible may comprise comparing the same (and/or corresponding) fields received in the Resource Utilization Responses received during 8007 and 8008. For example, a simple determination may just compare the PRB utilization and the QoS requirement probability in both these messages and select a target node for offloading that offers the better metric. However, there are multiple different fields that may be used for this comparison purpose. For example, the Resource Utilisation Response may comprise at least one of the following fields, with at least one of the comprised fields being used for comparative purposes for determining the feasibility:
a per PDU session level (and further per DRB)
   PRB utilization
   A measure of acceptance for this particular UE (e.g. load tolerable percentage 0-100, 0—fully tolerable, 50—partially tolerable, 100—fully intolerable).
Per Band and per component carrier level in case of carrier aggregation in this band
   Target cell/beam PRB load
   Percentage of total target cell/beam PRB load.
Probability that the QoS requirements of a given admitted PDU session are violated after the handover.
Probability that a given PDU session is dropped after the handover.
The degradation that the UE may experience in QoS for a given PDU session after the handover.
A “validity time” that indicates for how long the predicted information is valid for the above information beyond which a new consultation from the source is required.

In the present example, the serving access node determines that conditional handover is feasible for both the first target node and the second target node. This is determined by inspecting the information comprised in the resource utilization response comprised in the signalling of 8007 to 8008.

During 8010, the serving access node 802 signals the UE 801. This signalling of 8010 may prepare the UE 801 for conditional handover with any target node determined as being feasible during 8009. In the present example, this signalling of 8010 prepares the UE 801 for conditional handover with the first and second target nodes 803, 804. This signalling of 8010 may be a radio resource control (RRC) reconfiguration message.

During 8011, when an associated validity time indicated in the received signaling of 8007 to 8008 is reached, and/or when a prediction time is reached, and/or when a new measurement report is received from the UE 801, the serving access node 802 may obtain updated resource utilization request information. This may be performed through the following steps. It is understood that these steps may not be performed when the associated validity time/prediction time is not reached, and/or when a new measurement report is not received before handover is completed. The “prediction time” and the “validity time” differ in that the prediction time originates from the serving node and the “validity time” originates from the target node. For example, the serving nodes determines when it will trigger a new offloading and/or handover request based on a “prediction time” expiry time. This prediction time may be shorter than the “validity time” signalled by the target node during an earlier procedure. One reason why this may happen is when there is a change in the mobility pattern of the UE relative to when the validity time was obtained, which results in an updated time for performing the new offloading and.

During 8012, the serving access node 802 signals the first target node 803. This signalling comprise a mobility update request. This signalling may comprise a resource utilization request. This signalling may be as described above in relation to 8003.

During 8013, the first target node 803 calculates an updated incident load in response to the signalling of 8012. This signalling may be performed in a similar way to the operation of 8005.

During 8014, the first target node 803 signals the serving access node 802. This signalling of 8014 may comprise a resource utilization response to the signalling of 8012. The Resource Utilization Response may be as described above in relation to 8007.

During 8015, the serving access node 802 signals the second target node 804. This signalling may comprise a mobility update request. This signalling may comprise a resource utilization request. This signalling may be as described above in relation to 8004.

During 8016, the second target node 804 calculates an updated incident load in response to the signalling of 8015. This signalling may be performed in a similar way to the operation of 8006.

During 8017, the first target node 803 signals the serving access node 802. This signalling of 8017 may comprise a resource utilization response to the signalling of 8015. The Resource Utilization Response may be as described above in relation to 8008.

During 8018, the serving access node 802 uses the information provided during 8017 and 8014 to determine whether the target nodes providing their updated associated incident loads are feasible handover targets for the UE 801. In the present example, the serving access node 802 determines that the first target node 803 is still a feasible handover target, but further determines that the second target node 804 is no longer a feasible handover target.

In response to the determination of 8018 that the second target node 804 is no longer a feasible handover target for the UE 801, the serving access node 802 signals the second target node 804 during 8019. This signalling of 8019 may comprise an indication that the conditional handover of the UE 801 to the second target node 804 is being cancelled. This signalling of 8019 may comprise an indication indicating the reason why the conditional handover is being cancelled. For example, in the present example, the signaling of 8019 indicates that the conditional handover is being cancelled as a result of load mitigation measures.

During 8020, the second target node 804 releases any resources it has reserved and/or prepared for the conditional handover.

During 8021, the serving access node 802 removes a conditional handover preparation for the second target node 804. This may be performed by, for example, initiating a conditional handover cancellation procedure. For example, the conditional handover cancellation may be effected by the serving access node 802 signalling a conditional handover cancellation message to the second target node 804.

During 8022, the serving access node 802 signals the UE 801. This signalling of 8022 may indicate that the second target node 804 is no longer to be considered by the UE 801 for a conditional handover. The may be effected by removing, from UE 801, the handover prepared for the second target node 804, which means that the UE 801 will no longer consider the second target node 804 as a handover candidate any more. This signalling of 8022 may comprise a radio resource control reconfiguration signalling. This signalling of 8022 may indicate that the UE 801 should cancel and/or abandon any conditional handover preparation it has performed in respect of the second target node 804. In response to this signalling of 8022, the UE 801 may cancel and/or abandon any conditional handover preparation it has performed in respect of the second target node 804. As this signalling of 8022 is silent with respect to abandoning/cancelling conditional handover preparation in respect of the first target node 803 (and assuming no other equivalent signalling has been received in respect of the first target node 803), the UE 801 maintains its conditional handover preparation in respect of the first target node.

FIG. 9 illustrates another example.

In this example of FIG. 9, a given access node (e.g. the serving access node) may identify at least one UE that is in the coverage boundary of the given access node, and/or may identify at least one potential UE that is a candidate for outgoing mobility. The outgoing mobility may be considered to be handover of the at least one potential UE from the current serving node towards a potential target node(s). The given access node may subsequently trigger signalling to at least one neighbouring access node for estimating a resource load at the neighbouring access node. This signalling may comprise a “Group Resource Utilization Request Info” request. This signalling may comprise information for assisting the at least one neighboring access node in estimating the resource load. This signalling may comprise at least one of the following pieces of information:
As the UE is not yet known to the target/neighbouring node, a way of identifying and mapping the UE between the source and target gNB may be provided. This identifying and/or mapping may cause the source gNB to generate a RAN-specific temporary UE identifier (labelled herein as TEMP_UE_ID). This specific temporary identifier may be used to point to a particular UE's context information for the target node to make a per-UE resource load estimation.
At least one of the parameters described above in relation to FIG. 8's resource utilization request information
A TEMP_UE_ID with PARAMS={subset of UE capability, UE band combination, predicted UE load over time window “X”}, which allows the neighbour gNB to invoke the CALC_LOAD function and return the incident resource load for this temporary UE_ID over the time window “X”

The given/serving access node may further add information about the likelihood of the arrival of each of the UE(s), a time window “X” in which the UE(s) are likely to arrive which allows the target network node to estimate a range for the resource utilization to the Group Resource Utilization Request Info described above in relation to FIG. 8.

With this example of FIG. 9, an access node may collect the load results received from the neighbouring gNB(s) and can allow neighbouring nodes to be aware of at least one UE(s) that will be candidates for incoming mobility. This example method further allows these neighbouring nodes to be aware of the arrival time and probability of arrival so that these nodes are better prepared with their estimations.

FIG. 9 illustrates signalling that may be performed between a UE 901, a serving access node 902, a first target node 903, a second target node 904 and a location management function 904.

During 9001, the UE 901 signals the serving access node 902. This signaling may comprise a measurement report. Where there are multiple UEs, each of which signalling a respective measurement report to the serving access node 902, each of these signalled measurement reports may be signalled according to the configuration associated with each UE.

During 9002, the source UE uses the information signalled during 9001 to identify those UE located within its coverage area and/or within a coverage area of at least one neighbouring node, such as respective coverage areas provided by the first and/or second target node.

During 9003, the serving access node 902 signals the first target node 903. This signaling of 9003 may be a mobility update request. This mobility update request may request that the first target node 903 shares information about these UEs that might be potential candidates of incoming mobility to these targets.

This signalling 9003 may comprise a group resource utilization request information. The Group Resource Utilization Request Information may comprise any of the information described above in relation to the Resource Utilization Request Information.

This group resource utilization request may comprise a temporary UE identifier for the UE 901. This temporary identifier is labelled as TEMP_UE_ID in the following. This temporary identifier may be provided with PARAMS={subset of UE capability, UE band combination, predicted UE load over time window “X”}. This may allow the first target node to invoke the CALC_LOAD function and return the incident resource load for this temporary UE_ID over the time window “X” during 9005. The serving access node 902 may further add information to the Group Resource Utilization Request Info so that is comprises information about the likelihood of the arrival of each of the UE(s), a time window “X” in which the UE(s) are likely to arrive. This information may further be used by the first target node 903 for estimating a range for the resource utilization during the calculation of 9005.

During 9004, the serving access node 902 signals the second target node 904. This signaling of 9004 may be a mobility update request. This mobility update request may request that the second target node 904 shares information about these UEs that might be potential candidates of incoming mobility to these targets.

This signalling 9004 may comprise a group resource utilization request information. The Group Resource Utilization Request Information may comprise any of the information described above in relation to the Resource Utilization Request Information.

This group resource utilization request may comprise a temporary UE identifier for the UE 901. This temporary identifier is labelled as TEMP_UE_ID in the following. This temporary identifier may be provided with PARAMS={subset of UE capability, UE band combination, predicted UE load over time window “X”}. This may allow the first target node to invoke the CALC_LOAD function and return the incident resource load for this temporary UE_ID over the time window “X” during 9006. The serving access node 902 may further add information to the Group Resource Utilization Request Info so that is comprises information about the likelihood of the arrival of each of the UE(s), a time window “X” in which the UE(s) are likely to arrive. This information may further be used by the second target node 904 for estimating a range for the resource utilization during the calculation of 9006.

During 9005, the first target node 903 calculates an incident load for the UE(s) indicated in the signalling of 9003. This calculation may be performed as described above in relation to the calculation of incident load in FIG. 8.

During 9006, the second target node calculates an incident load for the UE(s) indicated in the signalling of 9004. This calculation may be performed as described above in relation to the calculation of incident load in FIG. 8.

During 9007, the first target node signals the serving access node 902. This signalling may comprise a mobility update response. This signalling of 9007 may comprise a group resource utilization response. This group resource utilization response may comprise analogous information to that provided above in relation to resource utilization response described above in relation to FIG. 8.

During 9008, the second target node signals the serving access node 902. This signalling may comprise a mobility update response. This signalling of 9008 may comprise a group resource utilization response. This group resource utilization response may comprise analogous information to that provided above in relation to resource utilization response described above in relation to FIG. 8.

During 9009, the serving access node 902 maintains, for each of the UEs determined in 9002, an indication of the incident load that the UEs have on each of the first and second target nodes.

During 9010, the serving access node 902 utilizes the incident load information for future mobility decisions. Mobility decisions may relate to decisions made in respect of, for example, handover from one node to another node, load balancing (including, for example, intra-frequency mobility load balancing, where a source/serving node can assess if handing a UE over to less favourable radio conditions in a neighbouring cell doesn't add an unacceptable load to the neighbouring node), setting up an interface (e.g. the Xn interface between network nodes for use during mobility procedures for transferring handover messages between a source/serving node and a target node),

The incident load information for each of the first and second target nodes may be updated at the source/serving access node by repeating the above-mentioned operations of 9003 to 9010. This will be discussed below in relation to 9011 to 9019.

At 9011, the serving access node 902 determines that a condition has occurred for requesting an update to the incident load information of the first and second target nodes.

During 9012, the serving access node 902 signals the first target node 903. This signaling of 9012 may be a mobility update request. This mobility update request may request that the first target node 903 shares information about these UEs that might be potential candidates of incoming mobility to these targets.

This signalling 9012 may comprise a group resource utilization request information. The Group Resource Utilization Request Information may comprise any of the information described above in relation to the Resource Utilization Request Information.

This group resource utilization request may comprise a temporary UE identifier for the UE 901. This temporary identifier is labelled as TEMP_UE_ID in the following. This temporary identifier may be provided with PARAMS={subset of UE capability, UE band combination, predicted UE load over time window “X”}. This may allow the first target node to invoke the CALC_LOAD function and return the incident resource load for this temporary UE_ID over the time window “X” during 9014. The serving access node 902 may further add information to the Group Resource Utilization Request Info so that is comprises information about the likelihood of the arrival of each of the UE(s), a time window “X” in which the UE(s) are likely to arrive. This information may further be used by the first target node 903 for estimating a range for the resource utilization during the calculation of 9014.

During 9013, the serving access node 902 signals the second target node 904. This signaling of 9013 may be a mobility update request. This mobility update request may request that the second target node 904 shares information about these UEs that might be potential candidates of incoming mobility to these targets.

This signalling 9013 may comprise a group resource utilization request information. The Group Resource Utilization Request Information may comprise any of the information described above in relation to the Resource Utilization Request Information.

This group resource utilization request may comprise a temporary UE identifier for the UE 901. This temporary identifier is labelled as TEMP_UE_ID in the following. This temporary identifier may be provided with PARAMS={subset of UE capability, UE band combination, predicted UE load over time window “X”}. This may allow the first target node to invoke the CALC_LOAD function and return the incident resource load for this temporary UE_ID over the time window “X” during 9015. The serving access node 902 may further add information to the Group Resource Utilization Request Info so that is comprises information about the likelihood of the arrival of each of the UE(s), a time window “X” in which the UE(s) are likely to arrive. This information may further be used by the second target node 904 for estimating a range for the resource utilization during the calculation of 9015.

During 9014, the first target node 903 calculates an incident load for the UE(s) indicated in the signalling of 9003. This calculation may be performed as described above in relation to the calculation of incident load in FIG. 8.

During 9015, the second target node calculates an incident load for the UE(s) indicated in the signalling of 9004. This calculation may be performed as described above in relation to the calculation of incident load in FIG. 8.

During 9016, the first target node signals the serving access node 902. This signalling may comprise a mobility update response. This signalling of 9016 may comprise a group resource utilization response. This group resource utilization response may comprise analogous information to that provided above in relation to resource utilization response described above in relation to FIG. 8.

During 9017, the second target node signals the serving access node 902. This signalling may comprise a mobility update response. This signalling of 9017 may comprise a group resource utilization response. This group resource utilization response may comprise analogous information to that provided above in relation to resource utilization response described above in relation to FIG. 8.

During 9018, the serving access node 902 maintains, for each of the UEs determined in 9002, an indication of the incident load that the UEs have on each of the first and second target nodes using the incident loads received during 9016 to 9017.

During 9019, the serving access node 902 utilizes the incident load information maintained during 9018 for future mobility decisions. These future mobility decisions may be as discussed above in relation to 9010.

For both of the examples of FIGS. 8 and 9, the serving access node may trigger a mobility update request to get updated information about the resource utilization at the prepared cells to decide to keep/release the prepared cells for CHO. Mobility update request can be initiated in response to a plurality of different trigger conditions. For example, the mobility update request may be transmitted upon receiving a new measurement from the UE after the conditional handover target cells are prepared. As another example, the mobility update request may be transmitted in response to a prediction time window “X” expiring. As another example, the mobility update request may be signalled in response to a validity time/period of the inference from target nodes expiring. The validity time may be considered as the time period for which model output information is valid. Note that, validity time can be coupled with the prediction time window “X” when time-series prediction at the target node is performed.

Further, for both of the examples of FIGS. 8 and 9, it may be assumed that the trajectory/position information of the UE may not be fully accurate. To address this, instead of one specific beam within a specific cell, the trajectory information may have a candidate set of possible beams like a “beam set” so that the prediction can be made for these set of beams.

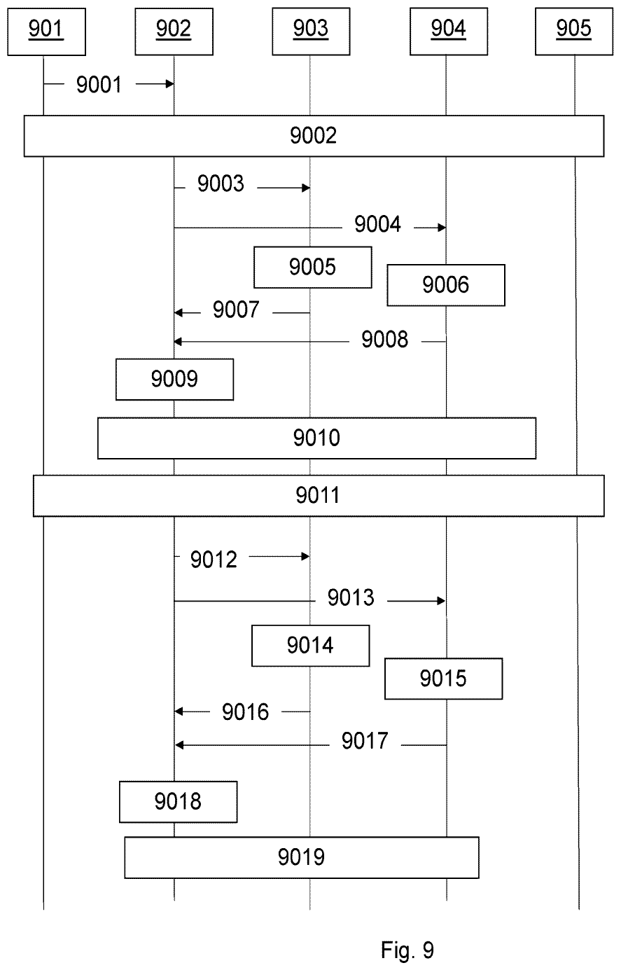

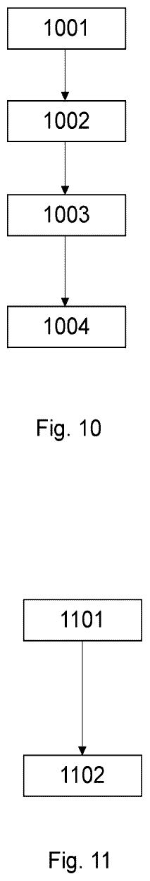

FIGS. 10 to 11 illustrate several operations that may be performed by apparatus described herein. It is understood that these Figures illustrate aspects of the above examples, and that the above examples may provide more specific features that may further be implemented in the following.

FIG. 10 is a flowchart illustrating operations that may be performed by an apparatus for a serving network access node.

At 1001, the apparatus provides a first user equipment with access to a network. In other words, the apparatus may be configured to act as a serving network access node to the first user equipment.

At 1002, the apparatus signals, to a first network access node, a request for a first indication that indicates how at least one load-related parameter of the first network access node would likely be affected if the first network access node were to serve the first user equipment.

This request of 1002 may be related to at least one of a plurality of different procedures. For example, this request may be related to a mobility-related procedure (such as, for example, conditional handover procedures), and/or to load-balancing procedures (such as, for example, carrier aggregation). Both mobility-related procedures and load-balancing procedures may be considered in the following to generally be load-related procedures. When the procedure is a handover procedure, the serving node may be labelled as a source node.

The first network access node may provide access to the same network as the network provided by the serving network access node to the first user equipment. The first network access node may be a neighbouring network access node to the serving network access node.

At 1003, the apparatus receives, from the first network access node, the first indication. This indication may be provided as part of the signalling related to a specific procedure. For example, when the procedure being considered/implemented is a conditional handover, the first indication may be received in an acknowledgement message for a conditional handover. The first indication may be comprised in, for example, resource utilization response, as described in the above examples.

At 1004, the apparatus may make at least one load-related decision for the first user equipment in dependence on the received first indication. As mentioned above, this at least one load-related decision may relate to at least a mobility-related procedure and/or to a load balancing procedure. This decision may result in the apparatus causing at least one apparatus to perform an action for putting that decision into effect. For example, the apparatus may configure (or to reconfigure) a list of potential target cells and/or network access nodes at the first user equipment for the purpose of conditional handover. As another example, the apparatus may configure the first network access node with information about other network access nodes and/or the first user equipment. Any subsequent reference in the following to making a decision may be related to at least one action being configured by the entity making the decision to put the decision into effect.

The making at least one load-related decision for the first user equipment in dependence on the received first indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said first indication; and when it is determined that the first network access node is a suitable network access node using said first indication, signalling the first user equipment, wherein said signalling to the first user equipment indicates that the first network access node is suitable to function as said another network access node. This procedure may relate to, for example, a conditional handover procedure.

The apparatus may signal, to the first network access node, a request for a second indication that indicates how at least one load-related parameter of the first network access node would likely be affected if the first network access node were to serve the first user equipment, wherein the request for the second indication is signalled after the request for the first indication is signalled. In other words, the apparatus may obtain an updated indication for how the at least one load-related parameter of the first access node would likely be affected. This request for second indication may be sent following a trigger event occurring. As one example, the trigger event may be the expiry of a validity time that was associated with the first indication. The apparatus may subsequently receive, from the first network access node, the second indication and make at least one load-related decision for the first user equipment in dependence on the received second indication.

The making at least one load-related decision for the first user equipment in dependence on the received second indication may comprise: determining that the first user equipment is configured to initiate a handover from the serving network access node to another network access node when the first user equipment determines that at least one execution condition is fulfilled at the first user equipment; determining whether the first network access node is a suitable network access node to function as said another network access node using said second indication; and, when it is determined that the first network access node is not a suitable network access node using said second indication, signalling the first user equipment, wherein said signalling to the first user equipment indicates that the first network access node is not suitable to function as said another network access node. When it is determined that the first network access node is a suitable network access node, the apparatus may use said first indication, and when it is determined that the first network access node is not a suitable network access node using said second indication, the apparatus may signal the first user equipment to indicate that the first neighbouring access node is no longer suitable to function as said another network access node.

The apparatus mat determine that at least one of a validity time of the first indication has expired, and/or that a measurement report has been received from a user equipment subsequent to the first indication being received, wherein said signalling, to the first network access node, the request for the second indication is performed response to said determining. In other words, the above mentioned trigger event may be at least one of a validity time of the first indication expiring and/or a measurement report being received from the user equipment subsequent to the first indication being received.

The apparatus may signal, to a second network access node, a request for a third indication that indicates how at least one load-related parameter of the second network access node would likely be affected if the second network access node were to serve the first user equipment; receive, from the second network access node, the third indication; and make at least one load-related decision for the first user equipment in dependence on the received third indication. These operations may be corresponding and/or analogous operations to those performed in respect to the first network access node. Consequently, the above (and below) discussion in respect of the first network access node may also apply in respect of the third network access node.

The apparatus may provide the received third indication to the first network access node, and provide the received first indication to the second network access node.

The apparatus may receive, from at least one of the first network access node and the second network access node, a load-related decision in relation to the first user equipment.

FIG. 11 is a flow chart illustrating operations that may be performed by an apparatus for a first network access node. The first network access node of FIG. 11 may be configured to interact with the serving network access node described in relation to FIG. 10. The first network access node of FIG. 11 may correspond to at least the first network access node of FIG. 10. The first network access node may be a neighbouring node to the serving network access node. The first network access node may be a target network access node when the procedures being considered are mobility-related.

At 1101, the apparatus receives, from a serving network access node serving a first user equipment, a request for a first indication that indicates how at least one load-related parameter of the first network access node would likely be affected if the first network access node were to serve the first user equipment, wherein the serving network access node is a neighbouring node to the first network access node. The first indication and signalling may be as described above in relation to the first indication of FIG. 10.

At 1102, the apparatus signals, to the serving network access node, the first indication.

The apparatus may receive, from the serving network access node, a request for a second indication that indicates how at least one load-related parameter of the first network access node would likely be affected if the first network access node were to serve the first user equipment, wherein the request for the second indication is signalled after the request for the first indication is signalled. This may relate to the request for an updated indication, as described above in relation to FIG. 10. The apparatus may signal, to the serving network access node, the second indication.

The apparatus may receive, from the serving network access node, a third indication that indicates how at least one load-related parameter of a second network access node would likely be affected if the second network access node were to serve the first user equipment; and make a load-related decision for the first user equipment using the first and/or third indication. The third network access node, like the example of FIG. 10, may be a neighbouring node to at least one of the first and serving network access nodes. In this example, the first network access node may become aware of how other, neighbouring network access nodes are performing. This information may be used when determining how network resources are to be allocated, and/or to control the actions of a user equipment accessing a network common to the serving, first, and second network access nodes for distributing network load.

The apparatus may receive, from the first user equipment, a request to perform a handover from the serving network access node to the first network access node. The apparatus may act on this request to facilitate the handover of the first user equipment from the serving network access node to the first network access node.

In both of the examples of FIGS. 10 and 11, the first indication may comprise at least one of:
a physical resource block utilisation at at least one of: a protocol data unit session level, a Data Resource Bearer level, carrier level, and/or a frequency band level;
a probability that a quality of service requirement of a session of the first user equipment will be violated subsequent to a handover of the first user equipment to the first neighbouring network access network node;
a validity time indicating a time duration for how long the first indication is valid;
a probability that a session of the first user equipment will be dropped subsequent to a handover of the first user equipment to the first neighbouring network access network node;
an indication of a predicted degradation in a quality of service requirement of a session of the first user equipment subsequent to a handover of the first user equipment to the first neighbouring network access network node.

In both of the examples of FIGS. 10 and 11, the request for the first indication may relate to a single user equipment (i.e. the request for the first indication may be performed at a per-UE level), and/or the request for the third indication may relate to a plurality of user equipment.

In both of the examples of FIGS. 10 and 11, the request for the first indication may comprise at least one of:
a channel quality indicator estimated based on a trajectory of the first user equipment;
an arrival rate of packets at the first user equipment per session of the first user equipment; and
service and/or slice information related to a service and/or slice provided at the first user equipment.

In both of the examples of FIGS. 10 and 11, the request for the first indication may be comprised in a “Resource Utilisation Request Info” signalling procedure.

In both of the examples of FIGS. 10 and 11, the request for the first indication may comprise a temporary identifier of the first user equipment. The apparatus of FIG. 10 may comprise means for generating said temporary identifier.

There are a plurality of advantages associated with at least one of the above-mentioned examples. For example, by using a UE-associated (i.e. per UE) and non-UE associated (i.e. for a group of UE(s)) method, a serving access node would be able to know in advance what is the incident load of its served UE(s) on a neighbouring gNB(s) possibly improving the mobility decisions e.g. performing an inter-frequency handover instead of an intra-frequency or influencing the methods in which measurements to the UE are configured.

Additionally, this method may allow a serving access node to use the resource prediction information as a potential measure of performance a UE will receive in deciding to initiate a handover to a potential cell/beam to ensure a UE receives a predetermined Quality of Experience (QoE).

Additionally, this method may allow an access node to identify potential hot spots of load (e.g. highly loaded cells and/or highly loaded beams in the network), as well as to determine whether it would be useful to deploy additional frequency layers in the network.

Additionally, this method may allow a serving access node to trigger load balancing actions such as, for example, changing a primary cell of given UE or a secondary cell addition or removal during the handover procedure.

Additionally, this method may allow a serving access node to trigger energy saving actions (e.g. cell or beam ON/OFF optimization).

Additionally, this method may allow a serving access node to trigger prioritization actions in the target network node(s).

Additionally, this method may allow a target access node to improve a load prediction accuracy in the target access node.

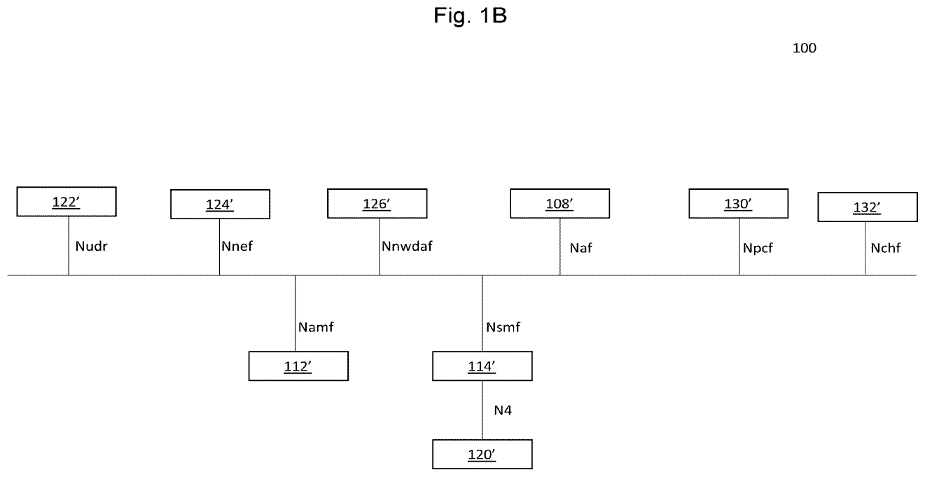

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

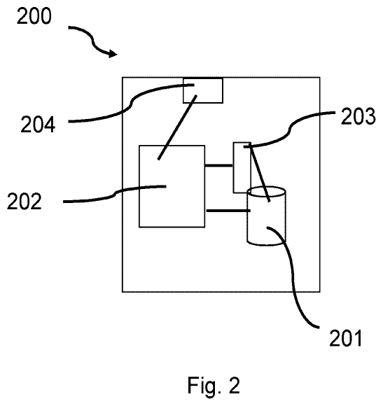

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or’ wireless) to other devices and/or for connecting external accessories, for example hands-free equipment, thereto.

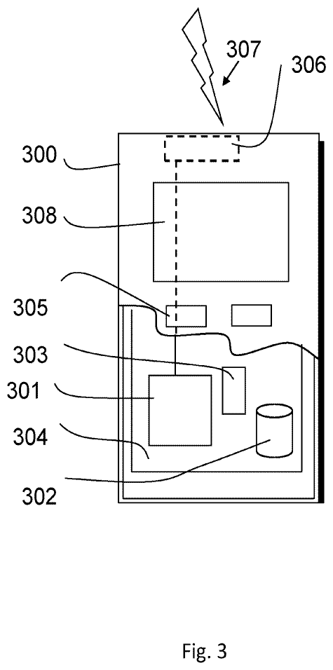

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 10 and/or FIG. 11.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 10 and/or FIG. 11, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally, some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

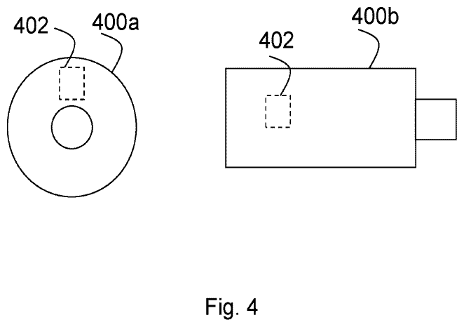

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 5). A HNB Gateway (HNB-GW), which is typically installed within an operator's network may aggregate traffic from a large number of HNBs back to a core network.

1.-22. (canceled)

23. An apparatus for a serving network access node, the apparatus comprising means for:
providing a first user equipment with access to a network;
signaling, to a first network access node, a request for a first indication that indicates how at least one load-related parameter of the first network access node would likely be affected if the first network access node were to serve the first user equipment;
receiving, from the first network access node, the first indication; and
making at least one load-related decision for the first user equipment in dependence on the received first indication.

24. The apparatus as claimed in claim 23, wherein the means for making at least one load-related decision for the first user equipment in dependence on the received first indication comprises means for:
determining that the first user equipment is configured to initiate a handover from the serving network access node to another network access node when the first user equipment determines that at least one execution condition is fulfilled at the first user equipment;
determining whether the first network access node is a suitable network access node to function as said another network access node using said first indication; and
when it is determined that the first network access node is a suitable network access node using said first indication, signaling the first user equipment, wherein said signaling to the first user equipment indicates that the first network access node is suitable to function as said another network access node.

25. The apparatus as claimed in claim 23, comprising means for:
signaling, to the first network access node, a request for a second indication that indicates how at least one load-related parameter of the first network access node would likely be affected if the first network access node were to serve the first user equipment, wherein the request for the second indication is signaled after the request for the first indication is signaled;
receiving, from the first network access node, the second indication; and
making at least one load-related decision for the first user equipment in dependence on the received second indication.

26. The apparatus as claimed in claim 25, wherein the means for making at least one load-related decision for the first user equipment in dependence on the received second indication comprises means for:
determining that the first user equipment is configured to initiate a handover from the serving network access node to another network access node when the first user equipment determines that at least one execution condition is fulfilled at the first user equipment;
determining whether the first network access node is a suitable network access node to function as said another network access node using said second indication; and
when it is determined that the first network access node is not a suitable network access node using said second indication, signaling the first user equipment, wherein said signaling to the first user equipment indicates that the first network access node is not suitable to function as said another network access node.

27. The apparatus as claimed in claim 24, further comprising means for, when it is determined that the first network access node is a suitable network access node using said first indication and when it is determined that the first network access node is not a suitable network access node using said second indication, signaling the first user equipment to indicate that the first neighboring access node is no longer suitable to function as said another network access node.

28. The apparatus as claimed in claim 25, further comprising means for determining that at least one of a validity time of the first indication has expired, and/or that a measurement report has been received from a user equipment subsequent to the first indication being received, wherein said signaling, to the first network access node, the request for the second indication is performed response to said determining.

29. The apparatus as claimed in claim 23, comprising means for:
signaling, to a second network access node, a request for a third indication that indicates how at least one load-related parameter of the second network access node would likely be affected if the second network access node were to serve the first user equipment;
receiving, from the second network access node, the third indication; and
making at least one load-related decision for the first user equipment in dependence on the received third indication.

30. The apparatus as claimed in claim 29, comprising means for:
providing the received third indication to the first network access node; and
providing the received first indication to the second network access node.

31. The apparatus as claimed in claim 30, comprising means for:
receiving, from at least one of the first network access node and the second network access node, a load-related decision in relation to the first user equipment.

32. An apparatus for a first network access node, the apparatus comprising means for:
receiving, from a serving network access node serving a first user equipment, a request for a first indication that indicates how at least one load-related parameter of the first network access node would likely be affected if the first network access node were to serve the first user equipment, wherein the serving network access node is a neighboring node to the first network access node; and
signaling, to the serving network access node, the first indication.

33. The apparatus as claimed in claim 32, comprising means for:
receiving, from the serving network access node, a request for a second indication that indicates how at least one load-related parameter of the first network access node would likely be affected if the first network access node were to serve the first user equipment, wherein the request for the second indication is signaled after the request for the first indication is signaled; and
signaling, to the serving network access node, the second indication.

34. The apparatus as claimed in claim 32, comprising means for:
receiving, from the serving network access node, a third indication that indicates how at least one load-related parameter of a second network access node would likely be affected if the second network access node were to serve the first user equipment; and
making a load-related decision for the first user equipment using the first and/or third indication.

35. The apparatus as claimed in claim 32, comprising means for receiving, from the first user equipment, a request to perform a handover from the serving network access node to the first network access node.

36. The apparatus as claimed in claim 32, wherein the first indication comprises at least one of:
a physical resource block utilization at at least one of: a protocol data unit session level, a Data Resource Bearer level, carrier level, and/or a frequency band level;
a probability that a quality of service requirement of a session of the first user equipment will be violated subsequent to a handover of the first user equipment to the first neighboring network access network node;
a validity time indicating a time duration for how long the first indication is valid;
a probability that a session of the first user equipment will be dropped subsequent to a handover of the first user equipment to the first neighboring network access network node; and/or
an indication of a predicted degradation in a quality of service requirement of a session of the first user equipment subsequent to a handover of the first user equipment to the first neighboring network access network node.

37. The apparatus as claimed in claim 32, wherein the request for the first indication relates to a single user equipment, and/or wherein the request for the third indication relates to a plurality of user equipment.

38. The apparatus as claimed in claim 32, wherein the request for the first indication comprises at least one of:
a channel quality indicator estimated based on a trajectory of the first user equipment; an arrival rate of packets at the first user equipment per session of the first user equipment; and/or
service and/or slice information related to a service and/or slice provided at the first user equipment.

39. The apparatus as claimed in claim 38, wherein the request for the first indication comprises a temporary identifier of the first user equipment.

40. A method for an apparatus for a serving network access node, the method comprising:
providing a first user equipment with access to a network;
signalling, to a first network access node, a request for a first indication that indicates how at least one load-related parameter of the first network access node would likely be affected if the first network access node were to serve the first user equipment;
receiving, from the first network access node, the first indication; and/or
making at least one load-related decision for the first user equipment in dependence on the received first indication.
